(19) United States
(12) Patent Application Publication
(10) Pub. No.: US 2026/0297890 A1
(43) Pub. Date: Oct. 1, 2026

(54) Control system for an articulated arm of an agricultural or work vehicle

(71) Applicant: CNH Industrial Italia S.p.A., Turin (IT)

(72) Inventors: Santolo Antonio Casillo, Lecce (IT); Fabio Dalla Rovere, Turin (IT); Alessio Aresta, Lecce (IT); Antonio Venezia, Modena (IT)

(73) Assignee: CNH Industrial Italia S.p.A., Turin (IT)

(21) Appl. No.: 19/631,824

(22) Filed: Mar. 27, 2026

(30) Foreign Application Priority Data
Mar. 27, 2025 (IT) 102025000006354

(51) Int. Cl. E02F 3/43; E02F 3/42

(52) U.S. Cl. CPC E02F 3/431; E02F 3/422

(57) ABSTRACT

A method of controlling an articulated arm of an agricultural or work vehicle is disclosed. The arm includes a first segment hinged to a vehicle frame and a second segment hinged to the first segment. The method includes detecting a current position of at least one of the segments and progressively reducing an actuation speed of the same segment as it approaches a respective end-of-travel position.

### FIELD OF THE INVENTION

The present invention relates to the field of control systems of an articulated arm of an agricultural or work vehicle.

### STATE OF THE ART

In the field of work and agricultural vehicles, the actuation of users, such as arms and related tools is achieved by means of a hydraulic circuit.

The hydraulic circuit is powered by a first hydraulic pump driven in rotation by a prime mover, very often an internal combustion engine.

In work machines, the most well-known and implemented parts are articulated arms equipped with buckets or forks or other devices connected to the arm.

The lifting and lowering of the arm is achieved by means of at least one double-acting linear hydraulic actuator. It comprises a pair of opposing chambers that fill and empty alternately to achieve the lifting or lowering of the arm. Similarly, a double-acting linear hydraulic actuator operates a bucket or fork connected to the arm, making the arm articulated.

The valve for controlling a hydraulic actuator is generally controlled by the operator by means of a joystick located in the vehicle's cockpit.

The electrical signal generated by the joystick is acquired by a processing unit, which processes it to control a directional control valve arranged to control the corresponding hydraulic actuator. The directional control valve is obviously of the electro-hydraulic type.

When the segments that define the articulated arm reach the end of their travel, there is a relative abrupt stop.

The actuation speed of each segment of the arm depends on the position of the shutter of the control direction valve, which depends exclusively on the electrical signal generated by the joystick.

Such abrupt stops lead to mechanical shocks and vibrations that over time can cause damage to the vehicle, both to the vehicle structure and to the hydraulic circuit actuating the arm. In fact, pressure peaks can be recorded that can damage the valves. In any case, such shocks and vibrations cause discomfort for the operator and fatigue of the musculoskeletal system.

Unless specifically excluded in the detailed description that follows, what is described in this chapter is to be considered as an integral part of the detailed description.

### SUMMARY OF THE INVENTION

The purpose of the present invention is to mitigate the effects resulting from the reaching of end-of-stroke positions by at least one segment of an articulated arm. The basic idea of the present invention is to implement at least one sensor to detect the position of a segment with respect to its respective constraint and to progressively reduce the actuation speed of the same segment as it approaches a respective end-of-stroke position.

In other words, a function called “soft-ending” is proposed. Advantageously, the present solution reduces the mechanical stress for the vehicle and increases the comfort for the human operator and the overall operating efficiency. The sensor can be of the angular type and fixed in proximity to the constraint of the segment being controlled, or it can be of the linear type associated with the stem of the actuator associated with the segment being controlled. According to a preferred aspect of the invention, a scheme for reducing the supply current of the directional valve is implemented.

Preferably, the scheme adopted is of the parabolic type. The dependent claims describe preferred variants of the invention, forming an integral part of the present specification.

### BRIEF DESCRIPTION OF THE FIGURES

Further objects and advantages of the present invention will be apparent from the following detailed description of an embodiment thereof (and variants thereof) and the accompanying drawings given purely for explanatory and non-limiting purposes, in which:

FIG. 1 shows an example of an agricultural or work vehicle which is the subject of the present invention;

FIG. 2 shows an example of a power circuit for the articulated arm of the vehicle of FIG. 1.

The same reference numbers and letters in the figures identify the same elements or components or functions.

It should also be noted that the terms “first”, “second”, “third”, “upper”, “lower” and the like may be used herein to distinguish various elements. These terms do not imply a spatial, sequential or hierarchical order for the modified elements unless specifically indicated or inferred from the text.

The elements and features illustrated in the various preferred embodiments, including the drawings, may be combined with each other without departing from the scope of protection of the present application as described below.

### DETAILED DESCRIPTION

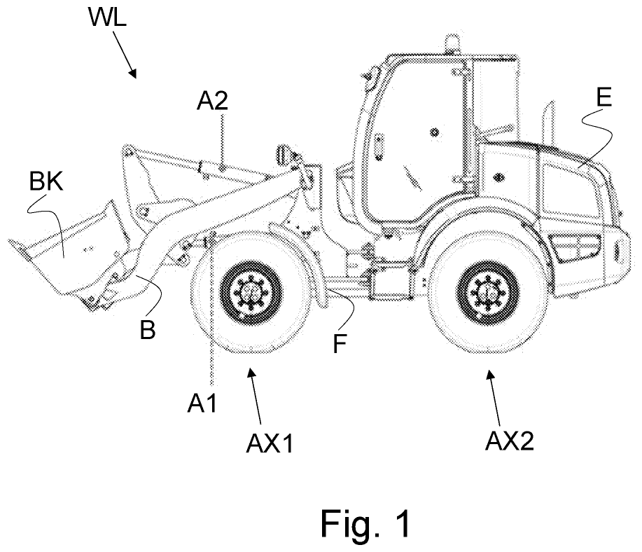

According to the present invention, a work vehicle WL such as a mechanical shovel, or an agricultural machine equipped with an articulated arm, i.e. an arm B to which a bucket BK or a fork is connected, see FIG. 1. Preferably, the vehicle is rubberized (wheel loader) and comprises a frame F, a front axle AX1, a rear axle AX2, a prime mover E that drives in rotation a hydraulic pump P that allows to pressurize a hydraulic circuit HC with which the hydraulic actuators A1, A2 are powered for the movement of an articulated arm B, BK. The arm B has a first end hinged to the frame F of the vehicle, while the bucket BK or fork is hinged to a second end of the arm, opposite to the first end of the arm.

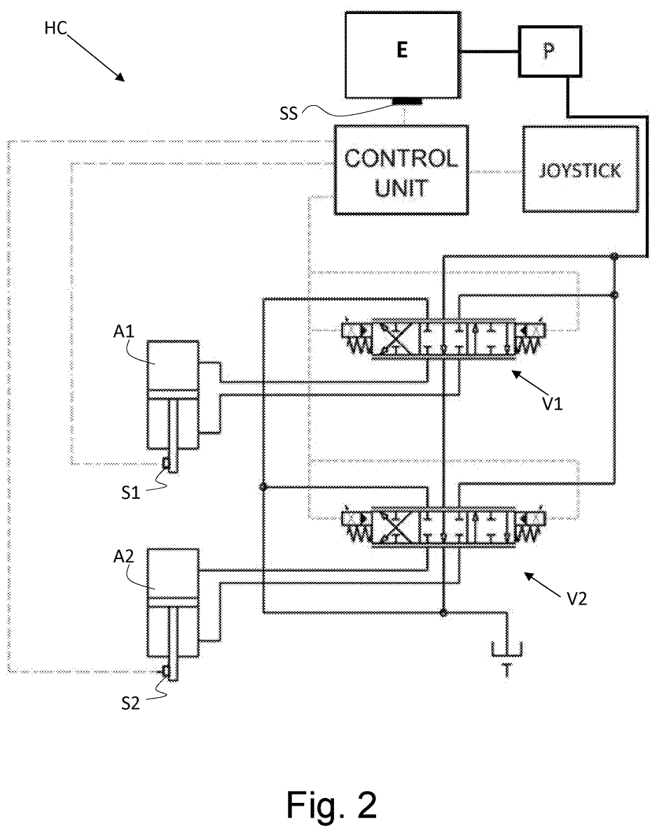

FIG. 2 shows an example of a simplified electro-hydraulic HC control scheme of the articulated arm B, BK. It is open-centered, however, the present invention finds application in both open-center and closed-center hydraulic circuits. The hydraulic actuator A1, also called double-acting hydraulic cylinder, comprises two opposing chambers: one arranged to obtain the lifting of the arm and the other to obtain the lowering of the arm.

While one chamber is operational thanks to the oil pumped by the hydraulic pump P, the other chamber, by contracting, releases the oil.

The actuator A1 is controlled by a proportional control valve V1, while the actuator A2 is controlled by a proportional control valve V2. These are preferably of the three-position type with a rest position that directly connects the supply line connected to the hydraulic pump P with the collection tank T.

Therefore, the pumped liquid is sent directly to the collection tank T.

In a first lateral position of the valve V1, for example left, the hydraulic pump P supplies a first chamber that causes the arm B to rise, while the second chamber, opposite to the first, is connected to the collection tank T. In the second lateral position, for example right, the hydraulic pump supplies the second chamber that causes the arm to lower, while the first chamber is connected to the collection tank T.

When the control valve V1 is in the central or rest position, the first and second chambers are closed, opposing any further movement of the arm.

The same concepts can be applied to the actuator A2 and the relative valve V2 of the bucket BK.

With reference to FIG. 2, a position sensor S1 and S2 is connected to each actuator respectively for the actuators A1 and A2.

By knowing the position of the actuators A1 and A2 it is possible to know the angular position of the arm with respect to the frame. Similarly it is possible to know the angular position of the bucket with respect to the arm.

Alternatively, angular sensors can be used, fixed, for example, directly in the hinges between the arm and the frame and/or between the bucket and the arm.

The valves V1 and V2 are proportional to a deflection of a relative control lever JOYSTICK, for example in the form of a joystick.

A processing unit CONTROL UNIT has the task of receiving an electrical signal generated by the joystick representing the position of the same with respect to a release position and an angular position of the segments B, BK of the articulated arm.

According to the present invention, the processing unit is configured to progressively reduce the actuation speed of at least one of the segments as it approaches a respective end-of-stroke position.

According to a preferred variant of the invention, a scheme for reducing the supply current of the corresponding directional valve V1, V2 is implemented.

Preferably, the scheme adopted is of the parabolic type. The following formula is representative of the value of the supply current I_lim [mA] of one of the directional valves V1, V2 according to the preferred parabolic scheme:

$${I}_{lim} = {I}_{0} + ( {I}_{max} - {I}_{0} ) ( \frac{θ - {θ}_{Target}}{Δ θ} )$$

$$where Δθ = \frac{{v}_{max}^{2} - {v}_{min}^{2}}{2 a} or Δθ = \frac{{\dot{θ}}_{max}^{2} - {\dot{θ}}_{min}^{2}}{2 \ddot{θ}}$$

with
Iₘₐₓ [mA] representative of the maximum current value corresponding to the maximum stroke of the valve shutter and therefore of the maximum actuation speed of the corresponding segment;
I₀ [mA] representative of the minimum current value that allows the corresponding segment to be moved;

$${v}_{max} or {\dot{θ}}_{max} [ \frac{deg}{s} ]$$

representative of the maximum speed value assumed by the actuator stem or of the corresponding angular speed of the segment around the respective constraint hinge;

$${v}_{min} or {\dot{θ}}_{min} [ \frac{deg}{s} ]$$

representative of the minimum speed value assumed by the actuator stem or of the corresponding angular speed of the segment around the respective constraint hinge in proximity to the settable limit position, close to or coinciding with the end-of-travel position;

$$a or \ddot{θ} [ \frac{deg}{{s}^{2}} ]$$

representative of the linear or angular deceleration constant to be imposed on the segment in proximity to the limit position;
θ [deg] representative of the current angular position of the segment with respect to a reference or home position;
θ_{Target} [deg] representative of the target angular position reached when the linear or angular velocity is equal to said minimum value vₘᵢₙ or \dot{θ}ₘᵢₙ and the valve supply current is equal to said minimum value I₀ [mA].

It should therefore be noted that the formula can be implemented both when the sensors are applied to the stems of the actuators and when the sensors are angular and applied to the hinges of the segment constraints that define the articulated arm.

It should also be noted that it is possible to set
End position limits: that is, it is possible to define the precise stopping point, which can be prior to the mechanical end-of-travel point to avoid any impact between the mutually moving parts;
Deceleration speed: that is, it is possible to set the deceleration speed independently for both opposing directions of movement;
End speed control: that is, it is possible to set the speed at which the arm or bucket reaches the end position, which can be set to zero or a positive value, in order to maintain high productivity while ensuring a soft stop.

All parameters are independently configurable for the lifting and lowering movements of the arm and/or the retraction and unloading of the bucket.

According to a preferred variant of the invention, the vehicle is equipped with a human/machine interface device that allows to set such parameters, for example a tactile display.

The processing unit CONTROLU UNIT comprising interfaces for receiving
a control signal of a segment of an articulated arm B, BK from the Joystick,
a signal representing an angular position of the segment, and for sending the current signal Iₗᵢₘ to a corresponding electro-hydraulic direction valve (V1, V2) for controlling the segment. The processing unit is configured to perform the method of the present invention.

According to a preferred aspect of the invention, the “soft-ending” function can be deactivated in predetermined operating conditions of the vehicle, for example when the operator wishes to command a bucket shake or perform a ground leveling position while the vehicle is moving backwards.

In such operating conditions of the vehicle, on the contrary, it is required that a segment impacts with respect to the respective constraint.

The deactivation of the “soft-ending” function can be positively controlled by the operator using the aforementioned human/machine interface device or it can be automatically deactivated when a function is activated that would be hindered by the soft-ending function, for example the bucket shaking function or the levelling function.

Alternative implementations of the invention are possible, for example, the use of other types of sensors, such as proximity sensors, and virtual sensors capable of estimating the position of a segment as a function of the time and degree of opening of the respective direction valve.

Different laws for reducing the supply current of the direction valves may also be implemented.

Furthermore, when the invention is applied to work vehicles other than a shovel, for example when applied to an excavator, then automatic deactivation may be performed as a consequence of the activation of a specific function of the excavator.

The present invention may advantageously be implemented by means of a computer program comprising coding means for the implementation of one or more steps of the method, when this program is executed on a computer. It is therefore intended that the scope of protection extends to said computer program and also to computer-readable means comprising a recorded message, said computer-readable means comprising program coding means for the implementation of one or more steps of the method, when said program is executed on a computer. Implementation variants to the non-limiting example described are possible, without however departing from the scope of protection of the present invention, including all the equivalent embodiments for a technician in the field, to the content of the claims.

From the description reported above, the technician in the field is able to realize the object of the invention without introducing further construction details.

1. A method for controlling an articulated arm of an agricultural or work vehicle, wherein the arm comprises at least a first segment hinged to a vehicle frame and a second segment hinged to the first segment, the method comprising:
detecting a current position of at least one of the segments; and
progressively reducing an actuation speed of the same segment as it approaches a respective settable limit position, close to or coinciding with an end-of-travel position.

2. The m method according to claim 1, wherein the at least one segment is actuated by a hydraulic actuator powered by a respective electro-hydraulic directional valve, wherein progressively reducing the actuation speed comprises reducing a supply current of the directional valve.

3. The method according to claim 1, wherein the actuation speed is progressively reduced following a parabolic trend.

4. The method according to claim 1, wherein progressively reducing the actuation speed comprises setting, for each of two opposing movements of the at least one segment, at least one of the following parameters:
a limit position, that precedes or coincides with the end position corresponding to a mechanical constraint switch,
a deceleration speed, and
a final speed with which the segment reaches said limit position.

5. The method according to claim 2, wherein progressively reducing the actuation speed comprises controlling a supply current of the directional valve using the formula Iₗᵢₘ [mA]:
$${I}_{lim} = {I}_{0} + ( {I}_{max} - {I}_{0} ) ( \frac{θ - {θ}_{Target}}{Δθ} )$$
$$Where Δ θ = \frac{{v}_{max}^{2} - {v}_{min}^{2}}{2 a} or Δθ = \frac{{\dot{θ}}_{max}^{2} - {\dot{θ}}_{min}^{2}}{2 \ddot{θ}}$$
With
Iₘₐₓ [mA] representing a maximum current value that corresponds to a maximum stroke of the valve shutter;
I₀ [mA] representing a minimum current value that allows said corresponding segment to move;
$${v}_{max} or {\dot{θ}}_{max} [ \frac{deg}{s} ]$$
representative of the maximum speed value assumed by the actuator stem or of the corresponding angular speed of the segment around the respective constraint hinge;
$${v}_{min} or {\dot{θ}}_{min} [ \frac{deg}{s} ]$$
representative of the minimum speed value assumed by the actuator stem or of the corresponding angular speed of the segment around the respective constraint hinge in proximity to the settable limit position, close to or coinciding with the end-of-travel position;
$$a or \ddot{θ} [ \frac{deg}{{s}^{2}} ]$$
representative of a linear or angular deceleration constant to be imposed on the segment in proximity to the settable limit position,
θ [deg] representative of a current angular position of the segment with respect to a reference or home position, and
θ_{Target} [deg] representative of said limit position reached when the linear or angular velocity is equal to said minimum value vₘᵢₙ or \dot{θ}ₘᵢₙ and the valve supply current is equal to the said minimum value I₀ [mA].

6-10. (canceled)

11. A work vehicle, comprising:
an articulated arm comprising:
a first segment hinged to a vehicle frame; and
a second segment hinged to the first segment; and
a control unit in communication with the articulated arm and configured to:
detect a current position of at least one of the segments, wherein the at least one segment is actuated by a hydraulic actuator powered by a respective electro-hydraulic directional valve; and
progressively reduce an actuation speed of the at least one segment as it approaches a respective end-of-travel position by controlling a supply current of the directional valve using the formula Iₗᵢₘ ham [mA]:
$${I}_{lim} = {I}_{0} + ( {I}_{max} - {I}_{0} ) ( \frac{θ - {θ}_{Target}}{Δθ} ) ,$$
$$wherein Δ θ = \frac{{v}_{max}^{2} - {v}_{min}^{2}}{2 a} or Δθ = \frac{{\dot{θ}}_{max}^{2} - {\dot{θ}}_{min}^{2}}{2 \ddot{θ}} ,$$
and
wherein
Iₘₐₓ [mA] representing a maximum current value that corresponds to a maximum stroke of the valve shutter;
I₀ [mA] representing a minimum current value that allows said corresponding segment to move;
$${v}_{max} or {\dot{θ}}_{max} [ \frac{deg}{s} ]$$
representative of the maximum speed value assumed by the actuator stem or of the corresponding angular speed of the segment around the respective constraint hinge;
$${v}_{min} or {\dot{θ}}_{min} [ \frac{deg}{s} ]$$
representative of the minimum speed value assumed by the actuator stem or of the corresponding angular speed of the segment around the respective constraint hinge in proximity to the settable limit position, close to or coinciding with the end-of-travel position;
$$a or \ddot{θ} [ \frac{deg}{{s}^{2}} ]$$
representative of a linear or angular deceleration constant to be imposed on the segment in proximity to the settable limit position,
θ [deg] representative of a current angular position of the segment with respect to a reference or home position, and
θ_{Target} [deg] representative of said limit position reached when the linear or angular velocity is equal to said minimum value vₘᵢₙ or \dot{θ}ₘᵢₙ and the valve supply current is equal to the said minimum value I₀ [mA].
